(19) United States
(12) Patent Application Publication
(10) Pub. No.: US 2015/0333675 A1
(43) Pub. Date: Nov. 19, 2015

(54) METHODS AND SYSTEMS TO IMPROVE DC MOTOR COOLING FAN EFFICIENCY WITH PULSE WIDTH MODULATION FREQUENCY VARIATION

(71) Applicant: GM GLOBAL TECHNOLOGY OPERATIONS LLC, Detroit, MI (US)

(72) Inventors: LEANDRO BARBOSA, SAO PAULO (BR); ALEX J. VELOSO, SAO PAULO (BR); ITALO QUEIROZ SOUZA, SAO PAULO (BR)

(73) Assignee: GM GLOBAL TECHNOLOGY OPERATIONS LLC, Detroit, MI (US)

(21) Appl. No.: 14/280,467

(22) Filed: May 16, 2014

(51) Int. Cl. H02P 7/29

(52) U.S. Cl. CPC H02P 7/29

(57) ABSTRACT

Methods, systems and a vehicle are provided for. The method provides for controlling pulse width modulation by a transistor based on the speed of a motor and a transfer function. The system includes a memory storing the transfer function, a transistor modulating an output current, a direct current power source providing the modulated output current to the motor via the transistor, a heat sink configured to absorb heat from the transistor and reflecting a transistor temperature, and a computing device, the computing device being configured to receive an electronic signal representing a desired speed of the motor and being configured to control the modulating input voltage, wherein the transistor produces the modulated output current at a switching frequency from the direct current power source based on the transistor temperature, and with a duty cycle based on the electronic signal as an input to the transfer function.

### TECHNICAL FIELD

The technical field generally relates to direct current (DC) motor speed control by low frequency pulse width modulation (PWM), and more particularly relates to improvement in the efficiency of a vehicle cooling fan DC motor by adjusting the PWM switching frequency and its Duty Cycle as a function of the PWM switching device and the DC motor speed conditions.

### BACKGROUND

Low frequency pulse width modulation (PWM) switching is an important technique used to vary the voltage that controls the speed of a DC motor driving a cooling fan. This is so because low frequency switching of a field effect transistor (FET) driving the PWM generates less heat than high frequency switching. Lower heat generation allows for a smaller heat sink, which is heavy and is relatively high cost. The definition of a “high” or “low” frequency is definite in reference to a motor with specific DC motor characteristics such as: nominal speed, number of poles, inductance characteristic and specified temperature considerations. As a non-limiting example, “low frequency” is defined herein as being lower than 1 kHz.

Pulse-width modulation (PWM), or pulse-duration modulation (PDM), is a modulation technique that conforms the width of a voltage pulse (i.e., the pulse duration) based on modulator signal information. Although this modulation technique can be used to encode information for transmission, its main use is to allow the control of the power supplied to electrical devices, especially to inertial loads such as motors. In use, the average value of voltage (and current) fed to the load is controlled by turning a switch (i.e., a transistor) between supply and load “on” and “off” at a fast pace. The longer the switch is “on” compared to the “off” time, the higher the power supplied to the load is.

A “period” is the time it takes for a signal to complete an on-and-off cycle. As a formula, a duty cycle may be expressed as:

$$D = \frac{T}{P} \times 100 \%$$

where D is the duty cycle, T is the time the signal is active, and P is the total period of the signal. Thus, a 60% duty cycle means the signal is on 60% of the time but off 40% of the time. The “on time” for a 60% duty cycle could be a fraction of a second, a day, or even a week, depending on the length of the period.

For practical purposes the PWM switching frequency (or 1/P) has to be much faster than what would affect the load, which is to say the device that uses the power. Generally, PWM switching is used in devices such as lamp dimmer, motor drive, electric stove, audio amplifiers and computer power supplies, with the switching frequency varying from few Hz to hundreds of kHz.

The term “duty cycle” describes the proportion of ‘on’ time to the regular interval or ‘period’ of time; a low duty cycle corresponds to low power, because the power is off for most of the time. Duty cycle is expressed in percent with 100% being fully on. FIG. 5 is a graph of the effect of different duty cycles on voltage. A pulse of period P₁ provides a voltage V₁. As the period of the pulse increases (e.g., P₂) V₂ increases, where T_{sysclk} is a clock increment.

Typically, the speed of a DC motor is controlled through a resistor card in series with the motor although there is a power loss dissipated as heat in the resistor, an energy waste. Thus, the PWM has a higher efficiency in controlling the DC motor speed due to lower power loss in the device and offer a finer speed control. The switching device power loss E_{diss} is a function of a resistance R_{ds} and the switching frequency given by:

E_{diss}=∫V_{FEToff}(t)×I_{FEToff}(t)dt+R_{ds}∫I_{FETon}(t)²dt+∫Vₜᵤᵣₙₒₙ(t)×Iₜᵤᵣₙₒₙ(t)dt+∫V_{turnoff}(t)×I_{turnoff}(t)dt Eq. 1

Wherein:
Ediss is the energy dissipated by FET,
VFEToff is the transistor voltage drop in off state,
IFEToff is the current through transistor in off state,
Rds refers to transistor resistance in on state,
IFETon is the current through transistor in on state,
Vturnon is the transistor voltage drop in turn on state,
Iturnon is the current through transistor in turn on state,
Vturnoff is the transistor voltage drop in turn off state,
Iturnon is the current through transistor in turn off state,
t is the time integrated during a certain period T.

With respect to Equation 1, FIG. 9 depicts illustrative waveforms of current and voltage in a field effect transistor (FET) with the respective power dissipated. FIG. 9 includes a first plot 902 having time (t) for the x-axis and current, voltage (I, V) for the y-axis, and a second plot 904 having time (t) for the x-axis and power (P) for the y-axis. The first plot includes a first region 906 in which the field effect transistor (FET) is turned off, a second region 908 in which the FET is turned on, and a third region 910 in which the FET is turned off. The second plot 904 includes a first region 912 in which conduction loss is turned on, a second region 914 in with conduction loss occurs, and a third region 916 in which conduction loss is turned off.

Considering a certain period of time as a reference, the dissipated energy (E_{diss}) tends to be greater when operating in high frequency due to the higher amount of transitions between saturation (switching device ON) and cut-off (switching device OFF) regions. Thus, the usage of low frequency switching PWM to drive a motor reduces the FET heating so that, the heat sink size and the system costs may be reduced.

However, low frequency PWM control has a detrimental effect on efficiency in terms of mechanical torque output per unit of electric power input. This is so because the amount of time that there is no power to the motor in each PWM period at low frequencies is greater than at high frequencies. This reduces the speed and torque during the period. Thus, during the “on” time the current delivered to the motor will be higher due to the speed lost during the “off” time, which results in a lower efficiency. This effect also detrimentally affects the motor start and is manifested in a longer time to reach the desired speed and higher peak currents, which cause stress to the system.

Accordingly, it is desirable to provide methods and systems to improve control system to efficiently control a vehicular cooling fan. In addition, it is desirable to dynamically vary the PWM switching frequency as a function of DC motor operating conditions, such as motor start, duty cycle and FET temperature. Furthermore, other desirable features and characteristics of the present invention will become apparent from the subsequent detailed description and the appended claims, taken in conjunction with the accompanying drawings and the foregoing technical field and background.

### SUMMARY

A method is provided for controlling pulse width modulated current by a transistor based on the speed of a motor and a transfer function. The method comprises receiving an electronic signal indicating a desired motor speed increase and comparing the electronic signal to the transfer function to determine a duty cycle of a motor current required to effectuate motor speed increase. When the speed increase is above a predefined value then increasing a switching frequency for the pulse width modulation to a specified high level, but at or below a specified maximum frequency, and altering the duty cycle based on based on a duty cycle change function that correlates the duty cycle with a duty cycle output value.

A system is provided for controlling pulse width modulation by a transistor based on the speed of a motor. In one embodiment, the system includes a memory storing a transfer function, a transistor with a modulating input voltage and a modulated output current, a direct current power source providing current to the motor via the transistor, a heat sink configured to absorb heat from the transistor resulting from the current, and a computing device. The computing device is configured to receive an electronic signal representing the desired speed of the motor and being configured to control the modulating input voltage, wherein the transistor produces the modulated output current at a switching frequency from the direct current power source based on the transistor temperature, and with a duty cycle based on the electronic signal as an input to the transfer function.

A vehicle is provided for comprising an electric motor, a transistor with a modulating input voltage and a modulated output current, a power source providing direct current to the motor via the transistor, and a computing device. The computing device.

### DESCRIPTION OF THE DRAWINGS

The exemplary embodiments will hereinafter be described in conjunction with the following drawing figures, wherein like numerals denote like elements, and wherein:

FIG. 1 is a simplified control system for a DC motor 40 in accordance with an embodiment;

FIG. 2 is a system diagram of a suitable control circuit in accordance with an embodiment; and

FIG. 3 is an illustrative graph of both the duty cycle and the average voltage of the output of the transistor versus time in accordance with an embodiment;

FIG. 4 is an exemplary graph of duty cycle change function where the duty cycle is increased toward a maximum over time;

FIG. 5 is an illustrative diagram of the relationship between pulse width and the voltage of the transistor output voltage;

FIG. 6 exemplary flow diagram of a method for controlling the duty cycle of the transistor output during a commanded speed increase;

FIG. 7 is an exemplary duty cycle output transfer function;

FIG. 8 is an exemplary flow chart of a method of controlling the switching frequency of the transistor output based on transistor temperature; and

FIG. 9 depicts illustrative waveforms of current and voltage in a field effect transistor (FET) with the respective power dissipated.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Those of skill in the art will appreciate that the various illustrative logical blocks, modules, circuits, and algorithm steps described in connection with the embodiments disclosed herein may be implemented as electronic hardware, computer software executing on a processor, or combinations of both. Some of the embodiments and implementations are described above in terms of functional and/or logical block components (or modules) and various processing steps. However, it should be appreciated that such block components (or modules) may be realized by any number of hardware and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software executed on a processor depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

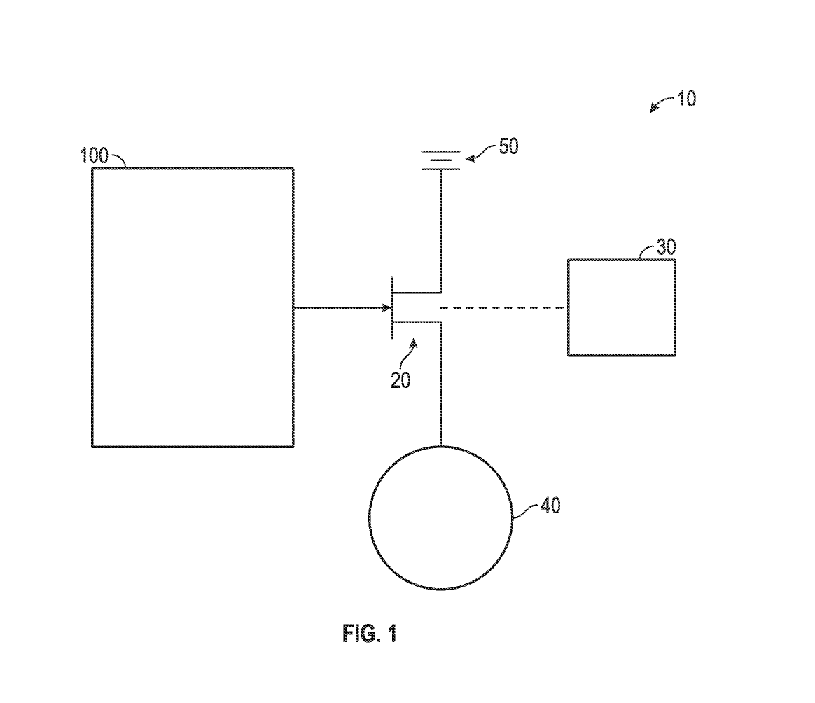

FIG. 1 is a simplified control system 10 for a DC motor 40, which may drive a cooling fan (not shown) in vehicle such as an automobile. The motor 40 receives power from a DC power source 50. The DC power source may be any suitable DC power source currently known in the art or that may be developed in a future. Exemplary non-limiting examples of suitable power sources include a battery, an AC/DC converter, a generator, and a transistor gate driver.

DC power from DC power source 50 is controlled by a transistor 20, which may be any suitable transistor currently know in the art or that may be developed in the future. As a non-limiting example, transistor 20 is a field effect transistor (FET). The periodicity of the DC power controlled by the transistor is controlled by the control circuit 100, further comprising a memory 101. Waste heat produced by the transistor is released into the environment, some or all of which is channeled through a heat dissipater or heat sink 30. The heat sink 30 may be any suitable heat sink currently known in the art or that may be developed in the future and may be constructed from any suitable material known in the art. Heat sink 30 may be in physical contact with the transistor 20, may surround the transistor, may be located a distance from the transistor but is in thermal contact with the transistor by conduction, convection and/or radiation. The heat sink 30 is required to maintain the temperature of FET (or other type of transistor 20) below its maximum operational junction temperature. For a FET, that temperature is approximately 150° C. Thus, the lower the heat being generated, the small the heat sink required.

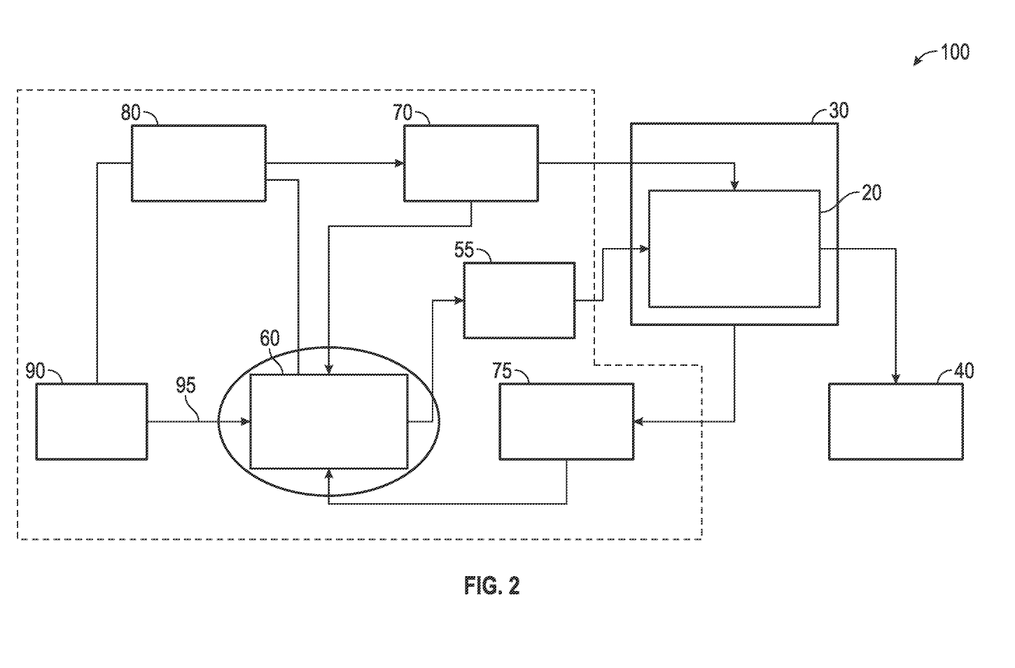

FIG. 2 is an expanded system diagram of control circuit 100. Control circuit 100 comprises a micro-controller 60 powered by power source 80, which may also be battery 50. Micro-controller 60 may any be any suitable computing device or processor known in the art or that may be developed in the future.

The micro-controller 60 receives a signal 90 from an engine management system (EMS) (not shown) indicating a requested engine cooling fan speed. The engine cooling fan speed is selected by the engine management system (EMS) according, but not limited to engine coolant and oil temperatures, vehicle speed, air conditioning loads, transmission oil temperature, and others vehicle conditions. The micro-controller also receives a temperature input from a temperature sensor 75 that senses the temperature of the heat sink 30 or the temperature of the closest surface that better represents the temperature of transistor 20, which is always cooler than the transistor 20. Temperature sensor 75 may be any suitable temperature sensor known in the art or that may be developed in the future. The micro controller 60 also receives a current input from current sensor 70 that senses current flow from battery 50 through the transistor 20. Current sensor 70 may be any suitable current sensor known in the art or that may be developed in the future.

The micro-controller 60 produces an electronic signal to the transistor gate 55 that controls the amount of current through the transistor 20, as is well known in the art. The electronic signal may be provided directly to the transistor 20, or it may be sent to an intervening gate driver 55 that then generates the gate signal to the transistor 20. Gate drivers are well known in the art and will not be described in further detail herein in the interest of clarity and brevity. The gate driver may be any suitable gate driver commensurate with the transistor and its operation.

The micro-controller 60 controls the activation of the transistor 20 based on the signal 90 from the EMS, the output current of the transistor 20 and the temperature of the transistor 20. The output current is monitored to avoid component damage due to over-current and to generate alerts due to over-current, short circuits and open circuits.

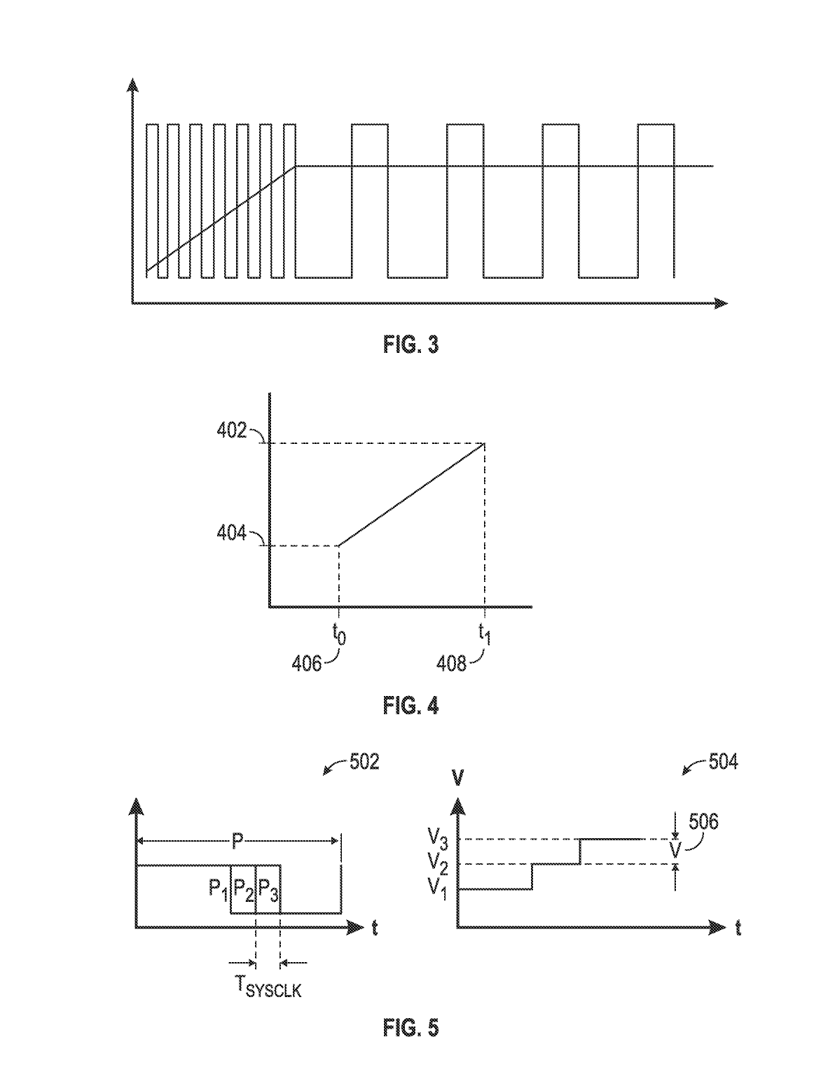

FIG. 3 is an illustrative graph of both the duty cycle and the average voltage of the output of the transistor 20 versus time and illustrates one of the concepts being disclosed herein. In FIG. 3, the x-axis represents duty cycle (in seconds), and the y-axis represents average voltage. Here, the microcontroller 60 handles the transistor 20 in order to start smoothly the motor DC 40 through a high frequency signal what by the time increases the transistor junction temperature. When the motor 40 achieves the desired speed and before the transistor achieves its maximum junction temperature, the microcontroller 60 reduces the operation frequency to a low value in order to decrease the transistor junction temperature. The PWM switching frequency is set to high in order to improve the system efficiency. The definition of a “high” or “low” frequency is definite in reference to a motor with specific DC motor characteristics such as: nominal speed, number of poles, inductance characteristic and specified temperature considerations. As a non-limiting example, “high frequency” is defined herein as being greater than 1 kHz.

The smoothly change disclosed herein in FIG. 3 is essentially linear. However, other smoothly changing functions could also be used. The relationship could also be chosen to vary exponentially, parabolically, asymptotically, and semispherically. Other curvilinear relations are also possible. The smoothly change strategy, namely here as duty cycle change function, is used to avoid the motor peak currents that can damage the system, and the smooth change can also be used during a speed change condition as will be described hereinafter. FIG. 4 is an exemplary graph of linear duty cycle change function where D_{OUT}_{_{—}}_{I} is the current duty cycle commanded to transistor 20, D_{OUT}_{_{—}}_{F} (shown as 402 in FIG. 4) is the final desired duty cycle, t₀ (shown as 406 in FIG. 4) is current (initial) time and t₁ (shown as 408 in FIG. 4) is the time that takes to achieve the D_{OUT}_{_{—}}_{F} value (shown as 404 in FIG. 4). In FIG. 4, the x-axis represents time (in seconds), and the y-axis represents duty cycle percentage. In one embodiment, the duty cycle change function correlates how the value of the duty cycle output value (output to motor 40) changes from the current value to a new value when there is a change in signal 90 (the desired speed).

FIG. 5 is an illustrative diagram of the relationship between pulse width and the voltage of the transistor output voltage to the motor 40. As the duty cycle of the of the transistor output increases by an incremental amount (e.g., P₃-P₂) that occurs in an incremental time period (T_{sysclock}), the voltage to the motor increases in a step wise amount from V₂ to V₃. The magnitude of the pulse width modulation resolution (measured in bits) is related to the period of the pulse (P) and the incremental time (T_{sysclock}) is given by the relationship:

PWM resolution=Log₂(P/T_{sysclock}),

or alternatively

PWM resolution=Log₂(f_{sysclk}/f_{PWM}),

where, f_{sysclk} is the frequency of the system clock and f_{PWM} is the frequency of the transistor output as seen by the motor 40. In FIG. 5, the first drawing 502 has temperature on the x-axis and pulse width modulation (PWM) on the y-axis. The second drawing 504 of FIG. 5 has time on the x-axis and voltage on the y-axis, and also depicts a voltage step 506.

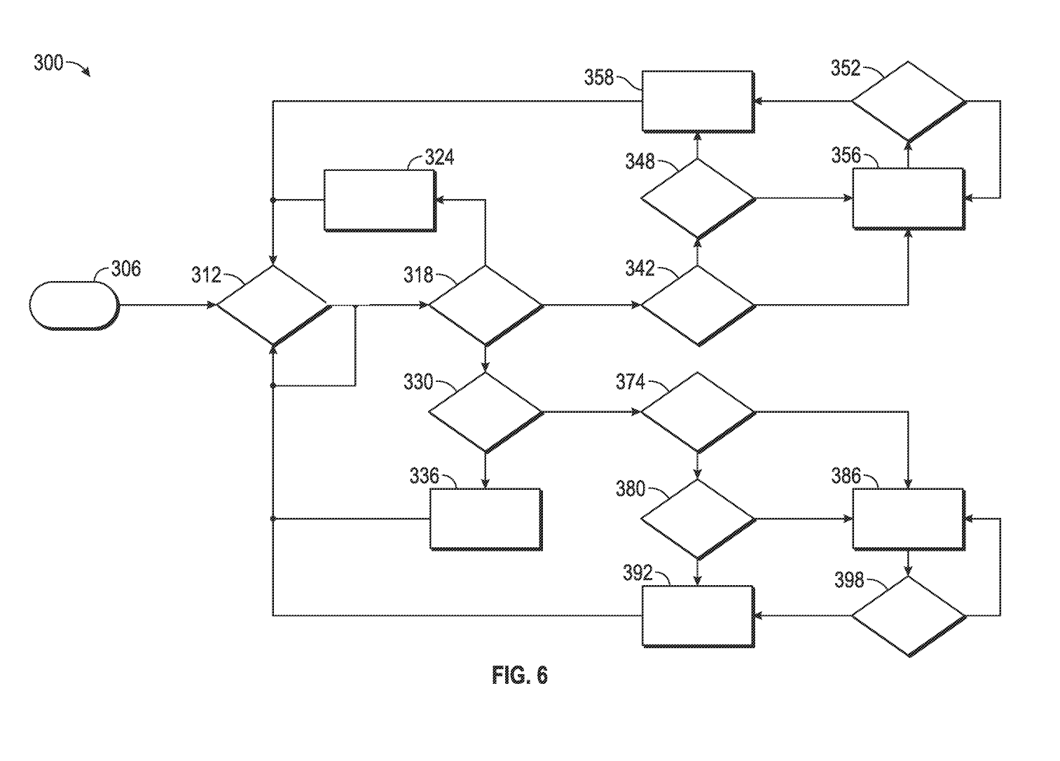

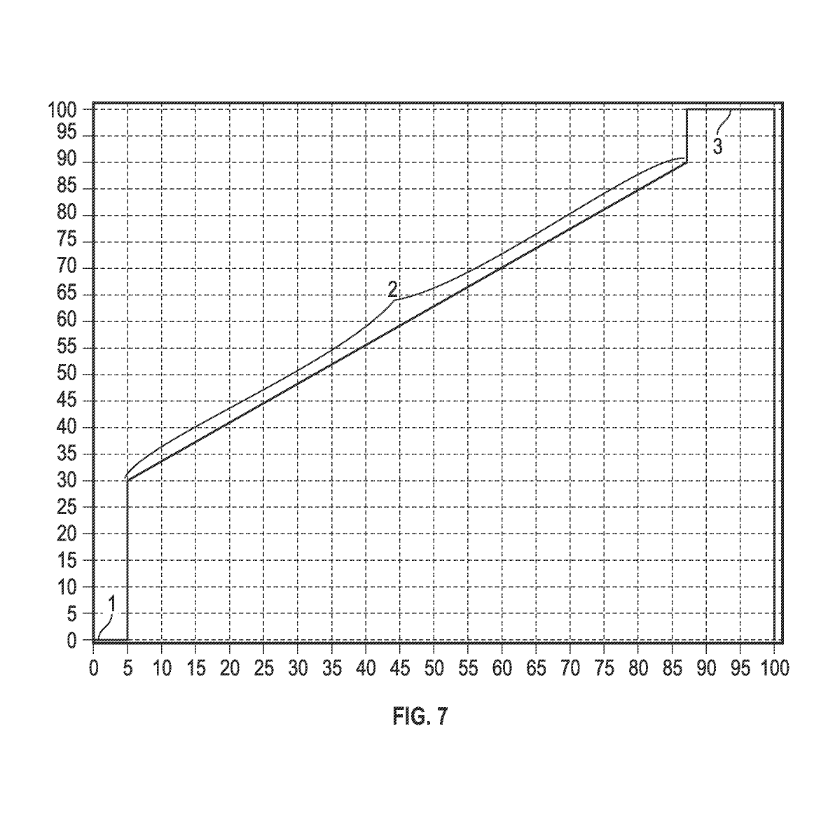

FIG. 6 is an exemplary flow diagram of a method 300 executed by microcontroller 60 for controlling the duty cycle and frequency of the transistor output based on input signal 90, temperature sensor 75, current sensor 70, and a previous motor state (Stopped, Running) It should be noted that the steps described herein below may be combined into fewer steps, split into sub-steps and/or rearranged without departing from the scope of this disclosure. It should further be noted that exemplary method 300 is tailored to operate with the various regions of the transfer function presented in FIG. 7. It will be clear to those of skill in the art that changing the transfer function or assigning different regions in the same transfer function of FIG. 7 would prompt corresponding adjustments to method 300.

For the sake of explanation, at start point 306 the motor 40 is assumed to be stopped. At decision point 312 a speed signal 90 indicating a desired speed is determined if the signal is greater than zero volts. When the speed signal 90 is greater than zero, the control circuit 100 refers to a transfer function stored in a memory such as the exemplary transfer function illustrated in FIG. 7 and determines which region of the transfer function is indicated by signal 90.

For example, when the signal 90 indicates region 1 of FIG. 7, the duty cycle of the current fed to the motor 40 is kept at zero at process 324 and the motor remains stopped. When the speed signal 90 indicates region 3 of exemplary FIG. 7, the method 300 proceeds to decision point 330 where the control circuit 100 determines if the signal indicates 100%, in which case a fault is indicated and the motor is shut down at process 336 (i.e., the current duty cycle is set to zero) for safety reasons. When it is determined at decision point 330 that speed signal 90 indicates less than duty cycle input of 100% in region 3, then the method 300 proceeds to decision point 374.

At decision point 374, the control circuit 100 determines if the motor 40 is stopped or is moving at a speed (indicated for example by a tachometer). When the motor 40 is moving it is determined at determination point 380 whether or not the difference between the current speed and the desired speed indicated by speed signal 90 is greater than a manufacturer predefined value (V). However, when the motor 40 is stopped, method 300 proceeds to process 386 (discussed below).

The manufacturer predefined value (V) is the maximum motor speed increase that does not result in an inrush current that is greater than the steady state current drawn at the new desired speed. “Inrush current,” or starting current, is the maximum, instantaneous current drawn by an electrical device when first turned on, a “inrush current” can also be a peak current due to motor speed variation. The value of V is motor dependent and will depend on such factors as speed, number of motor poles and inductance and may be established by experimentation or computer simulation.

When the speed differential at determination point 380 is less than the predefined value (V) then speed change is considered deminimus and the method 300 moves to process 392, where the switching frequency is set to zero, the output duty cycle is set to 100% and a motor state flag is set to “running” It should be noted that process 392 is specific to region 3 of the exemplary transfer function in this example, which is why the duty cycle is set to 100%.

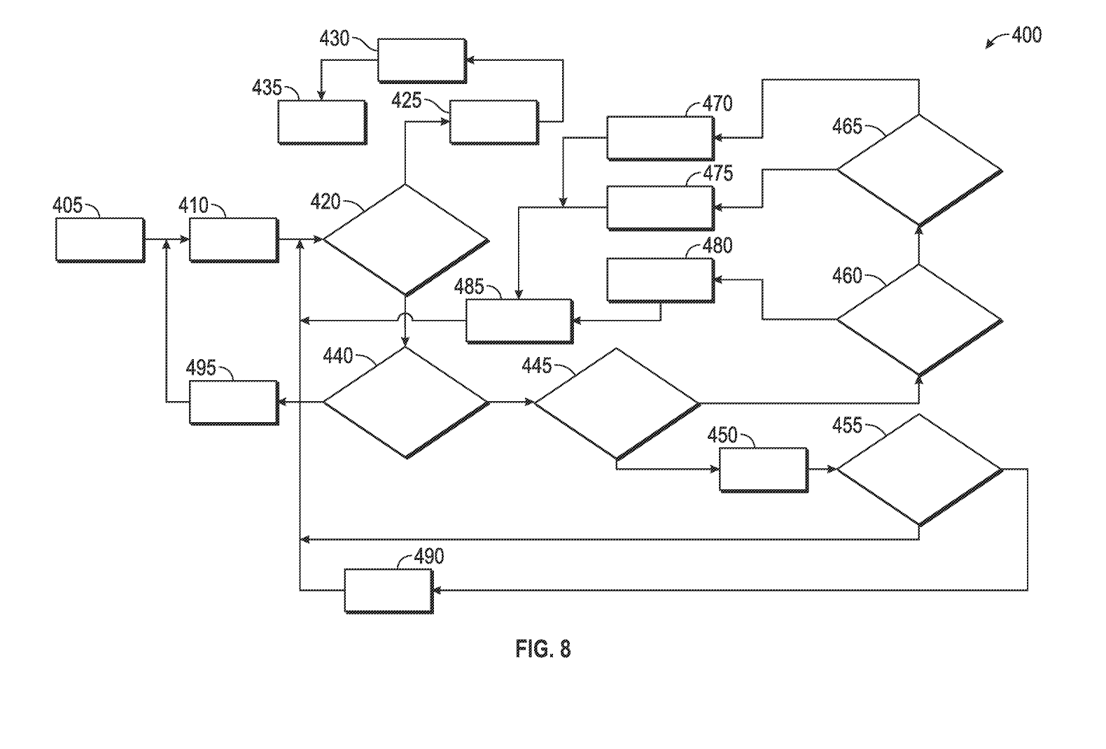

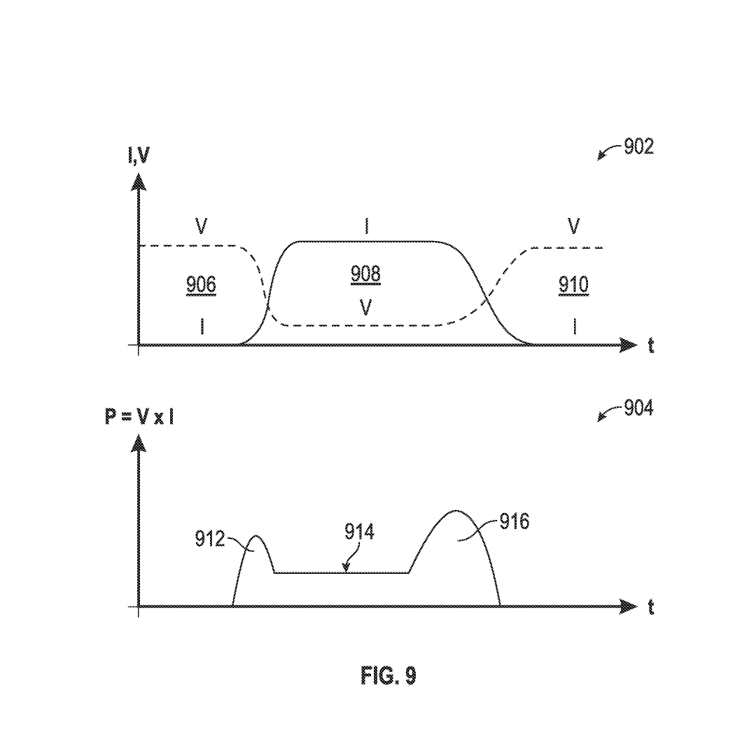

When the speed differential is determined to be greater than the predefined value (V) at determination point 380 then speed change is considered material and the method moves to process 386. In this case the switching frequency is set to high in accordance with the method 400 of FIG. 8 (discussed below) and the duty cycle is increased along to the duty cycle change function (as previously described) at process 386 to 100% stipulated in region 3. At this process the setting the switching frequency to “high” improves the efficiency of the motor during start up. When it is verified that the duty cycle reaches 100% based on the input duty cycle based at determination point 398 method 300 proceeds to process 392 (previously described above).

Returning to determination point 318, when the determination is made that the speed signal 90 indicates region 2 of the transfer function, the motor state is determined at determination point 342. When the motor 40 is determined to be stopped, the method proceeds to process 356 where the switching frequency is set to high (e.g.>1 kHz) to more efficiently start the motor 40 while the duty cycle is adjusted according to the duty cycle change function.

When the motor is determined to be running at process 342, it is determined whether the speed increase is greater than manufacturer predefined value (V) at determination point 348 at which point the switching frequency is set to high (e.g., 1 kHz) according to method 400 and the duty cycle is adjusted according to the duty cycle change function as previously discussed above until the desired duty cycle is determined to be reached at determination point 362. When the duty cycle reaches the desired duty cycle, method 300 moves to process 368 where the switching frequency is controlled pursuant to method 400, discussed below.

FIG. 7 is an output transfer function (region 2) relating an input duty cycle to the Control Circuit 100 and an output duty cycle delivered to the transistor 20. The transfer function is disclosed herein as being essentially linear. However, other functions could also be used. The relationship could also be chosen to vary exponentially, parabolically, asymptotically, and semispherically. Other curvilinear relations are also possible. The exemplary linear transfer function here is given by the equation:

DUTY_{OUT}=(D_{H}_{_{OUT}}−D_{L}_{_{OUT}})(DUTY_{IN}−D_{L}_{_{IN}})/(D_{H}_{_{IN}}−D_{—}L_{IN})−D_{L}_{_{OUT}} (Eq. 2)

Where:

D_{H}_{_{—}}_{OUT}=Output Final High Point value. (exemplary Default Value is 90%)

D_{H}_{_{—}}_{IN}=Input Final High Point value. (exemplary Default Value is 87%)

D_{L}_{_{—}}_{OUT}=Output Final Low Point value. (exemplary Default Value is 30%)

D_{L}_{_{—}}_{IN}=Input Final Low Point value. (exemplary Default Value is 5%)

D_{MAX}_{_{—}}_{IN}=Maximum Input Duty with 100% duty output (exemplary Default Value is 99%)

Thus, for a low input duty cycle (<5%; region 1) the output duty cycle is forced to zero, and at high input duty cycles (>87%; region 3) the output duty cycle is forced to 100%. In FIG. 7, input duty cycle (as a percentage) is used on the x-axis, and output duty cycle (as a percentage) is used on the y-axis. In one embodiment, the output transfer function correlates the value of the duty cycle in signal 90 (the desired speed) with the duty cycle output value (the output to motor 40).

FIG. 8 is an exemplary flow chart of a method of controlling switching frequency of the transistor output based on transistor temperature. Because heat is directly correlated with switching frequency (f), a variable frequency method is used to improve the efficiency of the transistor 20. Optimum efficiency of motor 40 is obtained at the maximum switching frequency (fₘₐₓ). However, instances of higher ambient temperatures may result in overheating of the transistor 20. Hence a lower frequency is used. This lower frequency is the maximum frequency less a predetermined frequency adjustment f0, f1 or f2, where f2>f1>f0. FIG. 8 uses input duty cycle (as a percentage) on the x-axis and output duty cycle (as a percentage) on the y-axis.

At process 405, an engine is started and a counter (N) is set to zero. Counter N counts the number of times that the transistor temperature exceeds a predefined upper temperature limit (T_lim). T_lim is component dependent. At process 410, the switching frequency (f) of the pulse width modulated power is increased (i.e., periodicity is decreased) to a maximum. For cooling fan control purposes being described herein by example, the maximum switching frequency (fₘₐₓ) will be 2 kHz.

At determination point 420, the control circuit 100 determines if the transistor temperature (T_tr) is greater than or equal to a maximum temperature (Tₘₐₓ). When the transistor temperature (T_tr) is greater than or equal to a maximum temperature (Tₘₐₓ), then a diagnostic indicator (D) is set at process 425 and the fan motor 40 is turned off at process 430. The diagnostic indicator (D) is then cleared at process 435.

When the transistor temperature (T_tr) is less than the maximum temperature (Tₘₐₓ), then it is determined at determination point 440 whether transistor temperature (T_tr) is greater or equal to the upper temperature limit (T_lim). For purposes of explanation herein, T_lim may be 135°, for example. When the transistor temperature (T_tr) is less than the upper temperature limit (T_lim), then the counter (N) is reduced by 1 at process 495.

When the transistor temperature (T_tr) is greater or equal to the upper temperature limit (T_lim), then the counter (N) is compared to a pre-determined value N2 at process 445, where N2 does not equal zero. When N equals value N2, then the switching frequency is set to zero at process 450 and it is again determined at determination point 455 whether transistor temperature (T_tr) is greater or equal to the upper temper limit (T_lim). When transistor temperature (T_tr) is greater or equal to the upper temper limit (T_lim) after the switching frequency is set to zero, the method 400 returns to determination point 420. When transistor temperature (T_tr) is less than the upper temperature limit (T_lim) after the switching frequency is set to zero, the counter (N) is set to N1 and the method 400 returns to determination point 420. N1 is less than N2.

When N does not equal value N2, then the method 400 proceeds to determination point 460, where the counter (N) is compared to a pre-determined value N1. N1 is less than N2. When N equals or is greater than value N1, then the switching frequency of the PWM power is set to (fₘₐₓ−f2), where f2 is an adjustable value. The counter (N) is incremented by 1 at process 485 and the method 400 returns to determination point 420. When N does not equal value N1 at determination point 460, then the method 400 proceeds to determination point 465.

At determination point 465, the counter (N) is compared to a pre-determined value N0, where N0 is less than N1. When N equals or is greater than value N0, then the switching frequency of the PWM power is set to (fₘₐₓ−f1), where f1 is an adjustable value and is less than f2. The counter (N) is incremented by 1 at process 485 and the method 400 returns to determination point 420.

When N does not equal value NO at determination point 465, then the switching frequency is set to (fₘₐₓ−f0), where f0 is an adjustable value and is less than f1. The counter (N) is incremented by 1 at process 485 and the method 400 returns to determination point 420.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling pulse width modulated current by a transistor based on the speed of a motor with a maximum switching frequency and a transfer function, comprising:
receiving an electronic signal indicating a desired motor speed increase;
comparing the electronic signal to the transfer function to determine a duty cycle of a motor current required to effectuate motor speed;
when the speed increase is above a predefined value then increasing a switching frequency for the pulse width modulation to a specified high level, but at or below a specified maximum frequency, and altering the duty cycle based on a duty cycle change function that correlates the new desired duty cycle value with the current duty cycle value.

2. The method of claim 1, further comprising:
when the speed increase is below the predefined value then holding the duty cycle according to the output transfer function and adjusting the switching frequency based on a transistor temperature, targeting to be at the maximum possible frequency within given temperature limits in order to increase the energy efficiency related to the electric cooling fan dc motor work for a given input power.

3. The method of claim 2, further comprising establishing transistor temperature limit, a first predefined frequency value, a digital counter (N), a first predefined counter value (N1), and a second predefined counter value (N2) in a memory; wherein the first predefined counter value (N1) is less than the second predefined counter value (N2).

4. The method of claim 3, wherein when the transistor temperature is less than the transistor temperature limit, then the counter (N) is decremented by 1 and the switching frequency is set to the maximum switching frequency.

5. The method of claim 3, wherein when the transistor temperature is greater than or equal to the transistor temperature limit, then comparing the digital counter (N) to the second predefined counter value (N2), wherein further when the digital counter (N) is less than the second predefined counter value (N2) setting the switching frequency to zero.

6. The method of claim 5, wherein when the transistor temperature is less than the transistor temperature limit then resetting the digital counter (N) to the first predefined counter value (N1).

7. The method of claim 5, wherein when the digital counter (N) is less than the second predefined counter value (N2), then determining if the digital counter (N) is greater than or equal to the first predefined counter value (N1), wherein when the digital counter (N) is greater than or equal to the first predefined counter value (N1), then reducing the switching frequency to a value equal to the maximum switching frequency less a first predefined frequency reduction value.

8. The method of claim 7, further comprising after reducing the switching frequency to a value equal to the maximum switching frequency less the first predefined frequency reduction value, then incrementing the digital counter by one.

9. The method of claim 5, wherein when the digital counter (N) is greater than or equal to a third predefined counter value (N0), wherein the third predefined counter value (N0) is less than the first predefined counter value (N1), then reducing the switching frequency to a value equal to the maximum switching frequency less a second predefined frequency reduction value.

10. The method of claim 9, further comprising after reducing the switching frequency to a value equal to the maximum switching frequency less a the second predefined frequency reduction value, then incrementing the digital counter by one.

11. A system for controlling pulse width modulation by a transistor based on the speed of a motor and a transfer function, comprising:
a memory storing the transfer function;
a transistor with a modulating input voltage and a modulated output current;
a direct current power source providing the modulated output current to the motor via the transistor;
a heat sink configured to absorb heat from the transistor resulting from the modulated output current and reflecting a transistor temperature, and
a computing device, the computing device being configured to receive an electronic signal representing a desired speed of the motor and being configured to control the modulating input voltage, wherein the transistor produces the modulated output current at a switching frequency from the direct current power source based on the transistor temperature, and with a duty cycle based on the electronic signal as an input to the transfer function.

12. The system of claim 11, wherein the duty cycle of the pulse width modulated output current is continually increased linearly.

13. The system of claim 11, wherein the switching frequency is driven to a lower frequency when a temperature of the heat sink, or any other location which better represents the transistor temperature, exceeds a predefined limit.

14. The system of claim 11, wherein the pulse width modulated output current is driven to zero when a temperature of the transistor exceeds a maximum limit above the predefined limit.

15. A vehicle comprising:
an electric motor;
a transistor receiving a modulating input voltage and generating a modulated output current at a switching frequency;
a power source providing direct current to the motor via the transistor; and
a computing device, the computing device is configured to receive an electronic signal representing a desired speed of the motor and being configured to control the modulating input voltage, wherein the transistor produces the modulated output current at a switching frequency from the direct current power source based on a transistor temperature, and with a duty cycle based on the electronic signal as an input to the transfer function.

16. The system of claim 15, wherein the duty cycle of the pulse width modulated output current is continually increased linearly.

17. The method of claim 10, wherein the switching frequency is driven to a lower switching frequency when the transistor temperature exceeds a predefined limit.
